(19) United States
(12) Patent Application Publication
(10) Pub. No.: US 2006/0012184 A1
(43) Pub. Date: Jan. 19, 2006

(54) Gaming machine lid/door latch

(76) Inventors: Kenneth Ottesen, Schaumburg, IL (US); Thomas Costanzo, Elmhurst, IL (US)

Correspondence Address: WEIDE & MILLER, LTD., 7251 W. LAKE MEAD BLVD., SUITE 530, LAS VEGAS, NV, 89128, US

(21) Appl. No.: 10/894,706

(22) Filed: Jul. 19, 2004

(51) Int. Cl. E05C 3/06

(52) U.S. Cl. 292/216

(57) ABSTRACT

A latch is provided for a door or lid of a gaming machine. A striker is mounted to the door or lid. A latch mechanism is mounted to a housing of the gaming machine. The latch mechanism comprises a body and a latch and a ratchet both rotatably supported by the body, the latch defining a striker accepting depression. The latch is movable between a first unlatched position in which the strike may be moved into or out of engagement with the latch, a second partially latched position in which the striker engages the latch and the ratchet engages the latch in a first position preventing the latch from moving from the partially latched to the unlatched position, and a third fully latched position in which the ratchet engages the latch in a second position preventing the latch from moving from the latched position.

### FIELD OF THE INVENTION

The present invention relates to gaming machines and, more particularly, to a latching mechanism for gaming machine lids and doors.

### BACKGROUND OF THE INVENTION

Gaming, including wager-type gaming, continues to grow in popularity. Casinos are now located in a large number of states and countries. In many instances, casinos may have many thousands of machines.

These machines generally include a cabinet defining an interior space. One or more access doors are provided to the interior space. The interior space houses the gaming machine display and control elements, such as video displays, reels, gaming controllers and the like.

The form of the gaming machine may vary. Many gaming machines are “upright” models. Generally, these models have a vertically extending door at the front of the cabinet. The door is hinged to swing open and closed. Another type of gaming machine is the “bar top” model. Often, this model is mounted so that its cabinet is located inside of a horizontal support, such as a bar top. A door, in the form of a lid, is mounted at the top of the cabinet. The lid may be lifted up and down. Yet another form of gaming machine is the “slant-top,” which may have a top opening lid and/or front opening door(s).

Generally, the door(s) or lid(s) of the gaming machines are configured so that they may be secured in a closed position to prevent undesired access to the interior thereof. As indicated, they are also configured to be moved between and open and closed position. As a result, gaming machines generally include a latch mechanism for holding the door or lid in a closed position, and a lock for locking the door or lid in its closed position.

Unfortunately, existing door or lid latches generally suffer from a number of drawbacks. As gaming machines have become larger and heavier, as do the associated doors or lids, the latch mechanisms may not have sufficient integrity to withstand repeated use. The latch mechanism are sometimes not effective in preventing undesired access to the interior of the gaming machine.

In addition, casino personnel must service the gaming machines. The service may include retrieving coins and cash from the machine, resetting the game machine, and performing routing maintenance and the like. Because of the large number of gaming machines which may be in a casino, these functions may need to be done quickly in order to keep the machines running. As the speed of service increases, technicians may quickly swing the doors or lids of the gaming machines open and closed. This motion may cause damage the gaming machine, especially when the door or lid is swung shut very quickly.

An improved lock or latch mechanism for a gaming machine door or lid is desired.

### SUMMARY OF THE INVENTION

The invention is a latch mechanism. The latch mechanism is particularly suited for use with a gaming machine having a housing and at least one door or lid moveable between a first position and a second position, the door or lid in the first position permitting access to at least a portion of an interior of the gaming machine, and the door or lid in the second position blocking access to the interior of the gaming machine. The latch mechanism is configured to retain the door or lid in its closed position.

In one embodiment, the latch mechanism comprises a supporting body or housing. A latch is rotatably supported by the body. The latch defines a striker accepting depression. A ratchet is also rotatably supported by the body.

The latch is movable between a first unlatched position in which a striker may be moved into or out of the striker accepting depression of the latch, a second partially latched position in which the striker is engaged by the latch and the ratchet engages the latch in a first position preventing the latch from moving from the partially latched to the unlatched position, and a third fully latched position in which the ratchet engages the latch in a second position preventing the latch from moving from the latched position and wherein the striker is engaged by the latch mechanism.

In one embodiment, the body of the latch mechanism is secured to the housing of the gaming machine. The striker is secured to the door or lid. In other embodiments, the latch mechanism may be secured to the door or lid, and the striker mounted to the housing. In one embodiment, the striker comprises a cylindrical rod which is mounted to a base, the base mounted or connected to the door or lid, or housing, depending upon the configuration.

Means are provided for biasing the latch towards its first position and for biasing the ratchet towards a position in which it engages the latch. In one embodiment, this means comprises a ratchet spring and a latch spring.

The latch mechanism includes means for releasing the latch from its latched position. A latch release comprises a member movably mounted to the body, the member having a portion configured to engage the ratchet when the body is moved from a first to a second position, the body when engaging the ratchet moving the ratchet towards a position in which it is disengaged from the latch. In one embodiment, the ratchet has an outwardly extending pin for selective engagement with the latch and a release extension extending away from the pin, the release extension for engagement by the release.

Another aspect of the invention is a method of latching and unlatching a door or lid of a gaming machine. In one embodiment, the method comprises moving the door or lid from an open position towards a closed position. A striker mounted to the door or lid is moved into a depression of the latch when the latch is in an unlatched position. The latch is rotated to a partially latched position in which the latch engages the striker. The ratchet is rotated into a first position in which it engages the latch and prevents the latch from moving from the partially latched to the unlatched position. The door is then further closed, rotating the latch from the partially latched position to a fully latched position. The ratchet is rotated into a second position in which the ratchet engages the latch and prevents the latch from moving from the latched position.

The method also includes the step of releasing the ratchet from engagement of the latch in the second position and rotating the latch from its latched to its unlatched position, allowing the striker to be released and the door or lid to be moved to its open position.

Further objects, features, and advantages of the present invention over the prior art will become apparent from the detailed description of the drawings which follows, when considered with the attached figures.

### DESCRIPTION OF THE DRAWINGS

FIG. 1 is a perspective view of one embodiment of a latch mechanism in accordance with the present invention;

FIG. 2 is a perspective view of a gaming machine having a housing and a lid, the housing supporting a latch mechanism of the invention and the lid supporting a striker, the latch mechanism permitting latching of the lid to the housing by engagement with the striker;

FIG. 3 is an exploded view of the latch mechanism illustrated in FIG. 1;

FIG. 4 is a perspective view of the latch mechanism illustrated in FIG. 1 shown in an unlatched position;

FIG. 5 is a simplified side view of the latch mechanism illustrated in FIG. 4, showing the latch mechanism prepared to engage a striker;

FIG. 6 is a perspective view of the latch mechanism illustrated in FIG. 1 shown in a partially latched position;

FIG. 7 is a simplified side view of the latch mechanism illustrated in FIG. 6, showing the latch mechanism engaging a striker; and

FIG. 8 is a perspective view of the latch mechanism illustrated in FIG. 1 shown in a fully latched position; and

FIG. 9 is a simplified side view of the latch mechanism illustrated in FIG. 8, showing the latch mechanism engaging a striker.

### DETAILED DESCRIPTION OF THE INVENTION

The invention is a latch mechanism for a gaming machine door or lid. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a latch mechanism for a door, lid or other moveable component of a gaming machine. The latch mechanism includes a striker which may be mounted to the door or lid. The latch mechanism also includes a latch and ratchet assembly configured to engage the striker. The latch is configured to be moved from a first, open or release position in which the striker may be inserted or removed from a striker recess therein, a second engaging position in which the striker is located in the striker recess, and third locked position in which the striker is fully locked and prevented from movement. The ratchet selectively engages the latch to maintain it in its second and third positions. A release mechanism allows the user to release the ratchet from the latch, permitting the latch to be moved from its locked or engaging position to the release or open position.

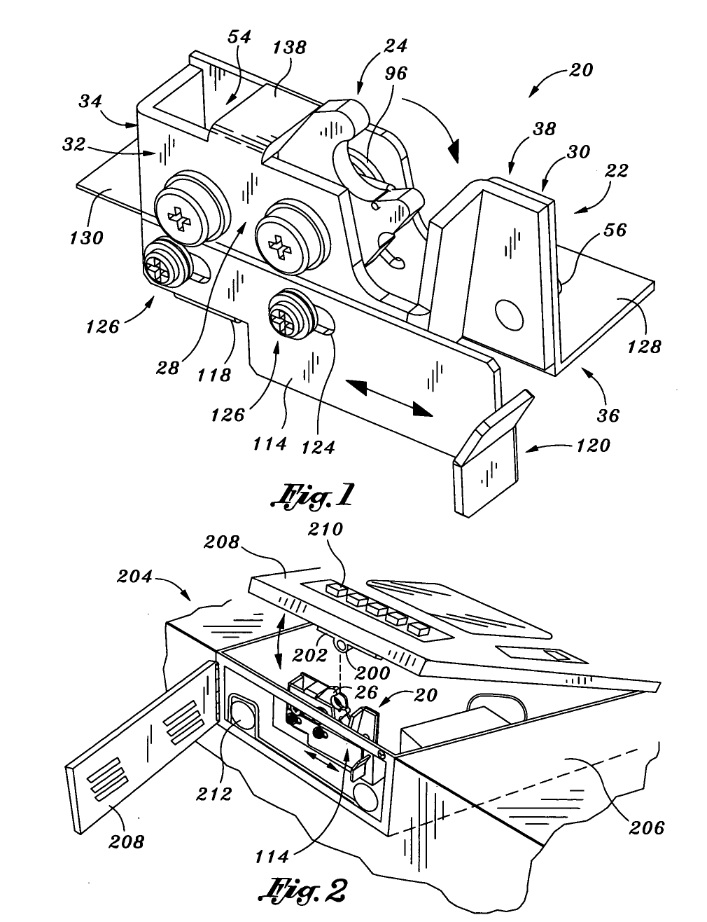

Referring to FIG. 1, one embodiment of a latch mechanism 20 of the invention is illustrated. As described in more detail below, the latch mechanism 20 is configured to selectively engage a striker.

In general, the latch mechanism 20 comprises a supporting body or housing 22, a latch 24 and a ratchet 26 (see FIG. 3), each of which is described in more detail below. The latch 24 is configured to selectively engage a striker. In a preferred embodiment, the latch 24 is movable between and into three distinct positions: (1) an unlatch position in which the striker may be engaged with or disengaged from the latch 24; (2) a partially latched position in which the striker is engaged by the latch 24 but the latch is not fully locked; and a (3) fully latched or locked position in which the striker is fully engaged by the latch 24. Each of these positions will be described in more detail below.

The overall construction of the latch mechanism 20 will be described with reference to FIGS. 1 and 3. The body 22 comprises a supporting structure for the latch 24 and ratchet 26. In one embodiment, the body 22 comprises a first supporting member 28 and a second supporting member 30. In one embodiment, the first supporting member 28 generally defines a first side 32 and opposing first and second ends 34,36 of the body 22, while the second supporting member 30 generally defines a second side 38 of the body 22 positioned generally opposite the first side 32.

Referring primarily to FIG. 3, in this configuration, the first supporting member 28 has a generally planar section 40 corresponding to the first side 32 of the device. This section 40 has a top edge 42 and a bottom edge 44, and a first end and an opposing second end. A first end member 46 extends from the first end generally perpendicular to the planar section 40, the first end member 46 generally defining the first end 34 of the body 22. Similarly, a second end ember 48 extends from the second end of the planar section 40, the second end member 48 has a first portion 50 which extends generally perpendicular to the planar section 40, defining the second end 36 of the body 22. The second end member 48 also has a second portion 52 which extends generally parallel to (but which is offset from) the planar section 40. As described in more detail below, the second portion 52 serves as a point of attachment of the first supporting member 28 and the second supporting member 30.

In one embodiment, the second supporting member 30 has the form of a generally planar plate. Referring to FIG. 1, when connected, the first and second supporting members 28,30 cooperate to define an interior space 54. As illustrated, the interior space 54 is generally bounded by the first and second end members 46,48 and planar section 40 of the first supporting member 28, and the second supporting member 30.

The first and second supporting members 28,30 may be connected in a number of ways. In one embodiment, when they are constructed of metal, they may be welded together. They may be bonded together in other ways, such as with adhesive. They may also be connected or joined with connectors. In one embodiment, as illustrated, a pin 56 extends outwardly from the first supporting member 28 for engagement with an aperture 58 in the second supporting member 30. The pin 56 aids in connecting and aligning the members 28,30. As described below, additional means are provided for joining the members.

As indicated, the body 22 supports the latch 24 and ratchet 26. In a preferred embodiment, the latch 24 and ratchet 26 are located substantially in the interior space 54 of the body 22.

The latch 24 and ratchet 26 are configured for movement, as described in more detail below. Referring to FIG. 3, the latch 24 has an aperture 60 therethrough. The aperture 60 is configured to accept a mounting shaft 62. As illustrated, the latch mounting shaft 62 has a first end supported by the second supporting member 30 (and in the embodiment illustrated, is fixedly attached to that member), and a second end which is supported by the first supporting member 28. In particular, as illustrated, the second end of the latch mounting shaft 62 is configured to pass through an aperture 64 in the first supporting member 28.

Means are provided for joining the second end of the latch mounting shaft 62 to the first supporting member 28. As illustrated, this means comprises a threaded fastener 66 (a washer 68 is also illustrated).

Similarly, the ratchet 26 has an aperture 70 for accepting a ratchet mounting shaft 72. Once again, the ratchet mounting shaft 72 has a first end supported by the second supporting member 30 (and in the embodiment illustrated, is fixedly attached to that member), and a second end which is supported by the first supporting member 28. As illustrated, the second end of the ratchet mounting shaft 72 is configured to pass through an aperture 74 in the first supporting member 28.

Likewise, means are provided for joining the second end of the ratchet mounting shaft 72 to the first supporting member 28. As illustrated, this means comprises a threaded fastener 76 (a washer 78 is also illustrated).

To facilitate movement of the latch 24 and ratchet 26 without binding and the like, the latch 24 and ratchet 26 maybe mounted between a pair of bushings 80, one bushing having the form of a washer, and the other the form of a sleeve on the respective shaft 62,72, or area of increased diameter of the shaft.

Still referring to FIG. 3, the latch 24 defines a striker accepting depression 82. As illustrated, the depression 82 is generally semi-circular in shape, and is positioned between a nose 84 and a foot 86 portion of the latch 24. At a portion of the latch 24 generally opposite the depression 82, the latch 24 includes a first step 88 and a second step 90. The first step 88 is located nearer a top of the latch 24, and is configured to accept a portion of the ratchet 26, as described in more detail below. The second step 90 is located below the first step 88, and is similarly configured.

The ratchet 26 includes an outwardly extending pin 92 and an outwardly extending release 94. The pin 92 is generally rectangular in shape and is configured to selectively engage (but not at the same time) the first step 88 and second step 90 of the latch 24. In the embodiment illustrated, the release 94 is a lever member extending generally downwardly from a main portion of the ratchet 26.

Means are provided for biasing the latch 24 and ratchet 26 into base positions. In one embodiment, this means comprise a latch spring 96 and a ratchet spring 98. As illustrated, the latch spring 96 comprises a coil spring having first end 100 and a second end 102. The first end 100 is preferably configured to engage an aperture 104 in the second supporting member 30. The second end 102 is configured to engage the latch 24. As illustrated, a slot 106 is formed in the foot portion 86 of the latch 24 for accepting the second end 102 of the latch spring 96. In this configuration, the latch spring 96 is preferably configured to bias the latch 24 upwardly into the position illustrated in FIG. 1.

Referring again to FIG. 3, similarly, the ratchet spring 98 comprises a coil spring having a first end 108 and a second end 110. The first end 108 is preferably configure to engage an aperture (not visible) in the second supporting member 30. The second end 100 of the ratchet spring 98 is configure to engage notch or slot 112 in the ratchet 26. Preferably, in this configuration, the ratchet spring 98 is configured to bias the ratchet 26 towards the latch 24 for engagement therewith.

Of course, other means may be provided for biasing the latch 24 and ratchet 26. The ends of the springs 96,98 may be fixed in a number of fashions, including with outwardly extending stops.

Means are provided for moving the ratchet 26 out of engagement with the latch 24, so that the position of the latch 24 may be changed, as described in more detail below. In one embodiment, this means comprises a release plate 114. As illustrated, the release plate 114 has a generally planar, plate-like main body 116. An actuator 118 extends outwardly from the body 116. As illustrated, the actuator 118 extends out from a bottom portion of the body 116 generally perpendicular to the body 116 and, when the actuator 118 is connected to the body 22, towards the body. An activator 120, in the form of a handle, is preferably located at an opposing portion of the body 116 of the release plate 114.

Preferably, the release plate 116 is mounted for movement relative to the body 22. As illustrated, a pair of mounts 122 extend outwardly from the first supporting member 28 for engagement with a pair of slots 124 in the release plate 116. Means are provided for securing the plate 116 to the body 22. As illustrated, a pair of fasteners 126 comprising, in this embodiment, threaded fasteners and washers, serve this purpose.

As described in more detail below, the release plate 116 can preferably be moved from a first position to a second position. When the plate is 116 is moved between these positions, the actuator 118 is configured to engage the release 94 of the ratchet 26, releasing the ratchet 26 from the latch 24.

Other means may be provided for selectively engaging and releasing the ratchet 26. For example, the release 94 of the ratchet 26 could extend below the body 22 and be directly engaged by the user. A pivoting lever could also be mounted to the side of the body 22, the lever when swung or pivoted in one direction engaging the release 94 and pressing the ratchet 26 away from the latch 24.

Referring to FIG. 1, the body 22 of the latch mechanism 20 may be configured for mounting to another device, such as described below, a gaming machine housing. As such, in one embodiment, the body 22 may include one or more mounting plates. As illustrated, one mounting plate 128 may extend outwardly from the second supporting member 30 generally perpendicular thereto. This mounting plate 128 may include one or more apertures (not visible) for accepting one or more fasteners. As illustrated, another mounting plate 130 extends from the first end 32 of the body 22. In one embodiment, this mounting plate 130 is also formed as an extension of the second mounting member 30 and may include one or more apertures therein.

As described above, the latch mechanism 20 is configured to selective engage a striker. FIG. 5 illustrates one embodiment of a striker 200. Greater details of the striker 200 are provided below. In general, the striker 200 comprises a member which is configured to be accepted in the striker depression 82 of the latch 24.

Referring to FIG. 3, the body 22 is preferably configured so that the latch 24 can accept the striker. As illustrated, the first supporting member 28 has a cut-away area 134 in the top edge 42 of the central portion 40 thereof. Likewise, the second supporting member 30 includes a similar cut-away area or depression 136.

Still referring to FIG. 3, in one embodiment, a latch stop 138 extends outwardly from the top edge 42 of the first supporting member 28. The latch stop 138 extends outwardly over the interior area 54 at a point slightly behind the latch 24 and engages a top portion of the latch 24 when the latch is in its unlatched position.

The components of the latch mechanism 20 maybe constructed from various materials and in a variety of ways other than as described. Preferably, the components of the latch mechanism 20 are constructed of metal so as to be durable and strong. Various of the components may be constructed integral with one another or be constructed as individual elements and then connected to one another. For example, the body 22 might be constructed of a plurality of elements which are connected, either via welding or other manners (for example, the first and second end members 46,48 and central planar section 40 of the first supporting member 28 may be constructed as a single element or of multiple elements which are connected).

The latch mechanism 20 is preferably used in conjunction with a gaming machine housing. FIG. 2 illustrates one such environment of use. As illustrated, this environment comprises a gaming machine 204. In the embodiment illustrated, the gaming machine 204 is configured as a “bar top” type machine in which the machine has a housing portion 206 and a lid portion 208. Various components of the gaming machine 204 are located in the housing portion 206 and are accessible by opening the lid portion 208.

In the embodiment illustrated, the housing 206 has a front panel 208 which may be opened and closed to provide access to the latch mechanism 20. As illustrated, the latch mechanism 20 is preferably connected to the housing portion 202 of the gaming machine 200. For example, the front panel 208 may be a lockable panel (such as locked with a rotating cam, key-operable lock). When open, this panel 208 provides only limited access to the interior of the gaming machine 204 and, namely, the latch mechanism 20.

Various components of the gaming machine 204 are preferably located in the housing 206 and/or mounted to the lid 208. For example, the gaming machine 204 may include a controller or CPU, a coin acceptor, a bill validator and bill storage case, a ticket acceptor, a ticket reader, a ticket printer, a card reader, one or more player input devices, such as buttons 210, speakers 212, and a wide variety of devices. In this regard, gaming machines having a wide variety of components and configured to present a wide variety of games are well known to those of ordinary skill in the art.

The striker 200 is preferably mounted to the lid 206. In particular, as illustrated, the base 202 is mounted to an inside portion of the lid 206. The striker 200 is positioned so that when the lid 206 is moved to its closed position, the striker 200 engages the latch 24 of the latch mechanism 20. Of course, the position of the striker 200 and latch mechanism 20 could be reversed, with the striker 200 connected to the housing and the latch mechanism connected to the lid 206 (or door or the like).

As illustrated in FIGS. 3 and 5, the striker 200 comprises a generally cylindrical body having a first end and a second end. In one embodiment, the ends of the striker 200 are supported by the base 202. The base 202 is configured for attachment to a mounting surface, such as the inside of a door or lid of a gaming machine. In one embodiment, the base 202 is generally planar and defines a pair of outwardly extending supports to which the ends of the striker 200 are connected. Of course, the base 202 may have a variety of configurations, including a variety of shapes and sizes. In one embodiment, the base 202 may define one or more apertures through which mounting elements such as bolts or screws may pass for mounting the base to the mounting surface. The particular size, including the circumference and length, of the striker 200 preferably depends upon the configuration of the corresponding latch 26 of the latch mechanism 20.

Preferably, the latch mechanism 20 is mounted so that the release 114 is, at one or more times, accessible, so that the latch 24 may be released, as described below. As indicated, in one embodiment, access to the release 114 may be controlled, such as via a lockable door, so that the latch 114 can not be released without authority.

It will be appreciated that FIG. 2 illustrates generally but one embodiment of a gaming machine 204 with which the latch mechanism 20 has particular utility. The latch mechanism 20 may be utilized with gaming machines configured in a variety of other manners. For example, the latch mechanism 20 may be used with gaming machines having one or more doors, such as a front door which rotates about a vertical axis. In this regard, a gaming machine 204 may include more than one latch mechanism 20, depending on the number of lids or doors the gaming machine includes. It will be understood that the terms “door” and “lid” may be used interchangeably herein, the term “lid” as used herein generally referring to a “door” which rotates in a generally vertical plane (i.e. about a horizontal axis).

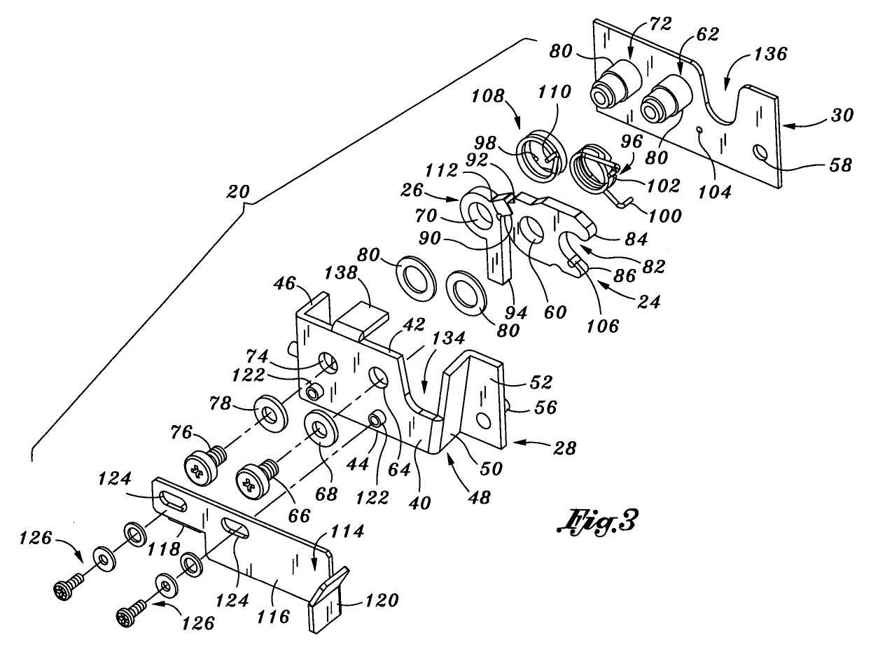

Operation of the latch mechanism 20 will now be described in greater detail with reference to FIGS. 4-9. First, referring to FIGS. 4 and 5, the latch 24 is configured to be positioned in a first or “unlatched” position. In this position, the ratchet (not illustrated) does not engage either step of the latch 24. In this position, the latch spring 96 biases the latch 24 upwardly so that the striker depression 82 is accessible.

In this position, as best illustrated in FIG. 5, the striker 200 may be moved into or out of engagement with the striker depression 82 of the latch 24. For example, lowering the lid 208 of the gaming machine 204 illustrated in FIG. 3 would cause the striker 200 to travel in along an arcuate path until it engages the latch 24. Likewise, from this position, the lid 208 could be raised, thus moving the striker 200 out of engagement with the latch 24.

As illustrated, in this latch position, the release plate 116 is located in a rear-most position, corresponding to the position of the ratchet 26 not engaging the steps in the latch 24.

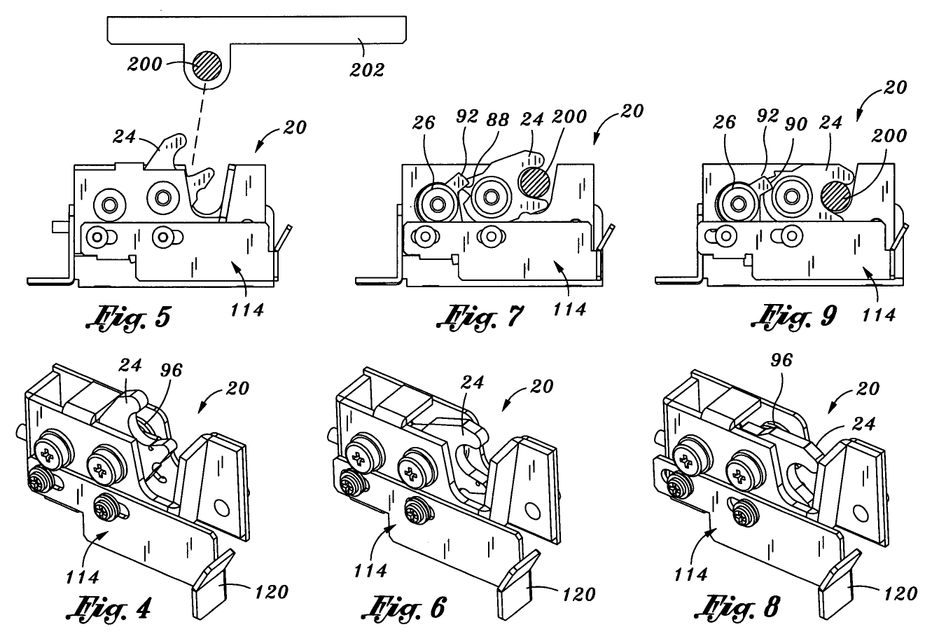

The latch 24 may be moved to a second, partially latched position. This position is best illustrated in FIGS. 6 and 7. As illustrated, in this position, the latch 24 is rotated downwardly, and the ratchet 26 preferably engages the first step 88 of the latch 24.

Preferably, this position is achieved as a result of downward pressure applied to the latch 24 via the striker 200. In particular, after the striker 200 is located in the striker depression 82 of the latch 82 and the striker 200 is pressed downwardly (such as by a closing action of the lid 208 of the gaming machine 204 illustrated in FIG. 3), the latch 24 is rotated so that the striker depression 82 moves downwardly.

As the latch 24 rotates, the ratchet 26 is caused to rotate under the biasing force of the ratchet spring 98. In particular, the pin 92 of the ratchet 26 is moved into a position in which it engages the first step 88 of the latch 24. In this position, the latch 24 is prevented from moving back to its unlatched position because of the engagement of the ratchet 26. Further, because of the position of the striker 200 located in the latch 24 and in the body 22 of the latch mechanism 20, the striker 200 can not be removed from the latch mechanism 20.

Lastly, the latch 24 may be moved to its fully latched position, as best illustrated in FIGS. 8 and 9. In this position, the latch 24 is rotated further downward and the pin 92 of the ratchet 26 engages the second step 90 of the latch. In this position, the striker 200 is secured by the latch 24 (and surrounding body 22) and is prevented from moving.

The striker 200 may be released from the latch 24. In particular, when the latch 24 is in its latched or partially-latched position, forward movement of the release 114 released the ratchet 26 from the latch 24, allowing the latch 24 to rotate upward to its unlatched position illustrated in FIGS. 4 and 5.

In the embodiment latch mechanism 20 described, forward movement of the release 114 may be effected by pulling the handle 120. As the release 114 moves forward, the actuator 118 moves forward, engaging the release 94 of the ratchet 26. As this occurs, the top of the ratchet 26, including the pin 92, is rotated rearwardly against the ratchet spring 98 away from the latch 26. When the ratchet 26 disengages the latch 24, the latch 24 is free to rotate upwardly, including under the bias of the latch spring 96.

As illustrated in FIG. 2, the latch mechanism 20 has particular applicability in the gaming environment. As described, a gaming machine, especially wagering-type gaming machines known as Class II and Class III gaming machines, typically have a cabinet. The cabinet comprises a housing with at least one door or lid. The door or lid is configured to move between an open and closed position, thereby permitting access to an interior of the gaming machine.

The gaming machine doors and lids are often relatively heavy. Moreover, the gaming machines generally contain sensitive equipment such as computer processing equipment, video displays, coin comparators and the like. These devices are susceptible to damage due to application of transmitted forces or shock. In many cases, the lids or doors themselves support sensitive equipment. For example, U.S. Published application Ser. No. 20030027627 discloses a gaming machine in which a thin-panel display is mounted to the door of the gaming machine.

In use, technicians and other gaming personnel, including those parties who empty the “cash boxes,” fill coins and replace receipts, open and close the door or lid of a gaming machine on a frequent basis. Quite frequently, these parties swing the door or lid of a gaming machine with rather high force in order to close it. This manner of closing the gaming machine door or lid may, as described above, damage the gaming machine equipment.

The latch mechanism 20 of the invention addresses these problems. First and foremost, the latch mechanism 20 is effective in securely latching a door or lid of a gaming machine. As described above, various configurations may be employed for locking the gaming machine so that the door or lid thereof can not be opened without access to the latch mechanism 20 and release of the latch mechanism 20 from its latched position.

In addition, the latch mechanism 20 is particular useful in latching swinging doors and lids of gaming machines. In particular, the latch mechanism 20 is configured to reduce the impact of a swinging door or lid. In the configuration illustrated, when a door or lid of the gaming machine is swung shut, the striker comes into contact with the latch. The force of the swinging door or lid is absorbed as the latch is rotated against the latch spring towards the partially-latched position. Most importantly, because the partially latched position is not the fully latched or stopped position, when the latch is moved to the partially latched position it does not abruptly stop, thereby causing a transmission of force to the gaming machine components.

If the swing force is very high, that force may cause the latch to be moved beyond the partially latched position and into the fully latched position. Again, this causes the swing force to be absorbed by the resisting force of the latch. Except in cases where the swing force is excessively high, the door or lid will stop at the partially latched position. Thereafter, the user applies pressure to move the door or lid so the striker and latch move to the fully latched position. Because this movement is relatively small in distance, the door or lid is not swung or slammed in order to move the latch. Instead, a smooth transitory force is applied, this force not being of the type which would cause damage to the gaming machine components.

Of course, the latch mechanism could have a number of applications or than that described herein. Further, it will be appreciated that the latch mechanism may have a variety of configurations other than that illustrated.

In one embodiment, the latch mechanism might include a key-operated release lock for the ratchet. For example, instead of the sliding plate release as described, the release could comprise the arm of a rotating lock member, the member rotatable only in response to the insertion of a key into the lock. In this manner, release of the latch might be effected by accessing a lock external to the gaming machine housing, such as through the use of a key.

As described, the latch mechanism preferably has three positions. The latch mechanism could be configured to have more than three positions, such as two intermediate partially latched positions.

Other means may be used to selectively lock the latch into the partially and fully latched positions other than the ratchet mechanism as illustrated.

As described, the body of the latch mechanism and the method and configuration for mounting the latch mechanism may vary depending upon the application. In addition, the size and construction of the latch mechanism may vary depending upon the application.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A latch for a gaming machine, the gaming machine having a housing and at least one door moveable between a first position and a second position, the door in the first position permitting access to at least a portion of an interior of the gaming machine, and the door in the second position blocking access to the interior of the gaming machine, the latch configured to selectively maintain the door in said second position, comprising:
a striker, said striker mounted to said door and movable with said door; and
a latch mechanism, the latch mechanism comprising a body, a latch rotatably supported by said body and a ratchet rotatably supported by said body, said latch defining a striker accepting depression, said latch movable between a first unlatched position in which said strike maybe moved into or out of said striker accepting depression of said latch, a second partially latched position in which said ratchet engages said latch in a first position preventing said latch from moving from said partially latched to said unlatched position, and a third fully latched position in which said ratchet engages said latch in a second position preventing said latch from moving from said latched position and wherein said striker is engaged by said latch mechanism.

2. The latch in accordance with claim 1 including at least one spring biasing said latch towards its first position.

3. The latch in accordance with claim 1 including at least one spring biasing said ratchet towards a position in which it engages said latch.

4. The latch in accordance with claim 1 including a ratchet release, said release comprising a member movably mounted to said body, said member having a portion configured to engage said ratchet when said body is moved from a first to a second position, said body when engaging said ratchet moving said ratchet towards a position in which it is disengaged from said latch.

5. The latch in accordance with claim 4 wherein said ratchet has an outwardly extending pin for selective engagement with said latch and a release extension extending away from said pin, said release extension for engagement by said release.

6. The latch in accordance with claim 1 wherein said latch has at least a first step and a second step and said ratchet includes a pin, said pin of said ratchet engaging said first step of said latch when said latch is in said partially latched position and said pin of said ratchet engaging said second step of said latch when said latch is in said fully latched position.

7. The latch in accordance with claim 1 wherein said second step is positioned below said first step.

8. The latch in accordance with claim 1 wherein said body generally defines an interior area, said latch and ratchet located in said interior area.

9. A method of latching a door of a gaming machine to a housing comprising:
moving said door from an open position towards a closed position;
moving a striker mounted to said door into a striker depression of a latch when said latch is in an unlatched position;
rotating said latch to a partially latched position in which said latch engages said striker;
rotating a ratchet into a first position in which the ratchet engages said latch and prevents said latch from moving from said partially latched to said unlatched position;
further closing said door;
rotating said latch from said partially latched position to a fully latched position in response to said further closing of said door;
rotating said ratchet into a second position in which the ratchet engages said latch and prevents said latch from moving from said latched position.

10. The method in accordance with claim 9 including the step of resisting said rotation of said latch.

11. The method in accordance with claim 10 wherein said step comprises generating a resistive biasing force with at least one spring.

12. The method in accordance with claim 9 including the step of releasing said ratchet from engagement of said latch in said second position and rotating said latch from said latched to said unlatched position.

13. The method in accordance with claim 9 including the step of moving said striker out of engagement with said latch.
